(19) United States
(12) Patent Application Publication
(10) Pub. No.: US 2024/0107396 A1
(43) Pub. Date: Mar. 28, 2024

(54) MAINTAINING COMMUNICATION ON A SOURCE CELL IN A CONDITIONAL HANDOVER

(71) Applicant: QUALCOMM Incorporated, San Diego, CA (US)

(72) Inventors: Lianghai JI, San Diego, CA (US); Yi HUANG, San Diego, CA (US); Linhai HE, San Diego, CA (US); Qiang WU, San Diego, CA (US); Jun MA, San Diego, CA (US); Xiao Feng WANG, San Diego, CA (US); Mehmet Izzet GURELLI, San Diego, CA (US); Weimin DUAN, San Diego, CA (US); Karthik ANANTHA SWAMY, La Jolla, CA (US)

(21) Appl. No.: 17/934,386

(22) Filed: Sep. 22, 2022

(51) Int. Cl. H04W 36/00

(52) U.S. Cl. CPC H04W 36/00837

(57) ABSTRACT

Various aspects of the present disclosure generally relate to wireless communication. In some aspects, a user equipment (UE) may receive information indicating a condition for a conditional handover, and an indication to communicate on a source cell after transmitting a message on a target cell, associated with the conditional handover, and before receiving an additional message on the target cell. The UE may transmit the message on the target cell responsive to the condition for the conditional handover being satisfied. Numerous other aspects are described.

### FIELD OF THE DISCLOSURE

Aspects of the present disclosure generally relate to wireless communication and to techniques and apparatuses for maintaining communication on a source cell in a conditional handover.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by an apparatus of a user equipment (UE). The method may include receiving information indicating a condition for a conditional handover, and an indication to communicate on a source cell after transmitting a message on a target cell, associated with the conditional handover, and before receiving an additional message on the target cell. The method may include transmitting the message on the target cell responsive to the condition for the conditional handover being satisfied.

Some aspects described herein relate to a method of wireless communication performed by an apparatus of a network node. The method may include generating information indicating a condition for a conditional handover, and an indication that a UE is to communicate on a source cell after transmitting a message on a target cell, associated with the conditional handover, and before receiving an additional message on the target cell. The method may include transmitting the information indicating the condition for the conditional handover, and the indication that the UE is to communicate on the source cell after transmitting the message on the target cell, associated with the conditional handover, and before receiving the additional message on the target cell.

Some aspects described herein relate to an apparatus for wireless communication at a UE. The apparatus may include a memory and one or more processors coupled to the memory. The one or more processors may be configured to receive information indicating a condition for a conditional handover, and an indication to communicate on a source cell after transmitting a message on a target cell, associated with the conditional handover, and before receiving an additional message on the target cell. The one or more processors may be configured to transmit the message on the target cell responsive to the condition for the conditional handover being satisfied.

Some aspects described herein relate to an apparatus for wireless communication at a network node. The apparatus may include a memory and one or more processors coupled to the memory. The one or more processors may be configured to generate information indicating a condition for a conditional handover, and an indication that a UE is to communicate on a source cell after transmitting a message on a target cell, associated with the conditional handover, and before receiving an additional message on the target cell. The one or more processors may be configured to transmit the information indicating the condition for the conditional handover, and the indication that the UE is to communicate on the source cell after transmitting the message on the target cell, associated with the conditional handover, and before receiving the additional message on the target cell.

Some aspects described herein relate to a non-transitory computer-readable medium that stores a set of instructions for wireless communication by a UE. The set of instructions, when executed by one or more processors of the UE, may cause the UE to receive information indicating a condition for a conditional handover, and an indication to communicate on a source cell after transmitting a message on a target cell, associated with the conditional handover, and before receiving an additional message on the target cell. The set of instructions, when executed by one or more processors of the UE, may cause the UE to transmit the message on the target cell responsive to the condition for the conditional handover being satisfied.

Some aspects described herein relate to a non-transitory computer-readable medium that stores a set of instructions for wireless communication by a network node. The set of instructions, when executed by one or more processors of the network node, may cause the network node to generate information indicating a condition for a conditional handover, and an indication that a UE is to communicate on a source cell after transmitting a message on a target cell, associated with the conditional handover, and before receiving an additional message on the target cell. The set of instructions, when executed by one or more processors of the network node, may cause the network node to transmit the information indicating the condition for the conditional handover, and the indication that the UE is to communicate on the source cell after transmitting the message on the target cell, associated with the conditional handover, and before receiving the additional message on the target cell.

Some aspects described herein relate to an apparatus for wireless communication. The apparatus may include means for receiving information indicating a condition for a conditional handover, and an indication to communicate on a source cell after transmitting a message on a target cell, associated with the conditional handover, and before receiving an additional message on the target cell. The apparatus may include means for transmitting the message on the target cell responsive to the condition for the conditional handover being satisfied.

Some aspects described herein relate to an apparatus for wireless communication. The apparatus may include means for generating information indicating a condition for a conditional handover, and an indication that a UE is to communicate on a source cell after transmitting a message on a target cell, associated with the conditional handover, and before receiving an additional message on the target cell. The apparatus may include means for transmitting the information indicating the condition for the conditional handover, and the indication that the UE is to communicate on the source cell after transmitting the message on the target cell, associated with the conditional handover, and before receiving the additional message on the target cell.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of a regenerative satellite deployment and an example of a transparent satellite deployment in a non-terrestrial network (NTN), in accordance with the present disclosure.

FIG. 5 is a diagram illustrating an example of a four-step random access procedure, in accordance with the present disclosure.

FIG. 6 is a diagram illustrating an example of conditional handover, in accordance with the present disclosure.

FIG. 7 is a diagram illustrating an example of a conditional handover timeline, in accordance with the present disclosure.

FIG. 8 is a diagram of an example associated with maintaining communication on a source cell in conditional handover, in accordance with the present disclosure.

FIG. 9 is a diagram illustrating an example process performed, for example, by a UE, in accordance with the present disclosure.

FIG. 10 is a diagram illustrating an example process performed, for example, by a network node, in accordance with the present disclosure.

FIG. 11 is a diagram of an example apparatus for wireless communication, in accordance with the present disclosure.

FIG. 12 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

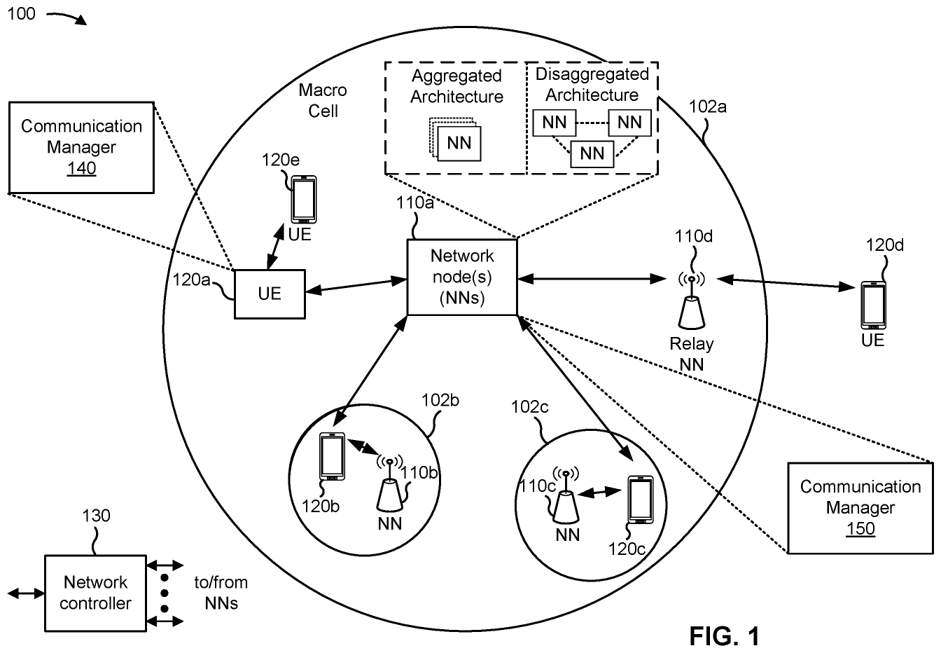

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive information indicating a condition for a conditional handover, and an indication to communicate on a source cell after transmitting a message on a target cell, associated with the conditional handover, and before receiving an additional message on the target cell; and transmit the message on the target cell responsive to the condition for the conditional handover being satisfied. Additionally, or alternatively, the communication manager 140 may perform one or more other operations described herein.

In some aspects, the network node 110 may include a communication manager 150. As described in more detail elsewhere herein, the communication manager 150 may generate information indicating a condition for a conditional handover, and an indication that a UE is to communicate on a source cell after transmitting a message on a target cell, associated with the conditional handover, and before receiving an additional message on the target cell; and transmit the information indicating the condition for the conditional handover, and the indication that the UE is to communicate on the source cell after transmitting the message on the target cell, associated with the conditional handover, and before receiving the additional message on the target cell. Additionally, or alternatively, the communication manager 150 may perform one or more other operations described herein.

As indicated above, FIG. 1 is provided as an example. Other examples may differ from what is described with regard to FIG. 1.

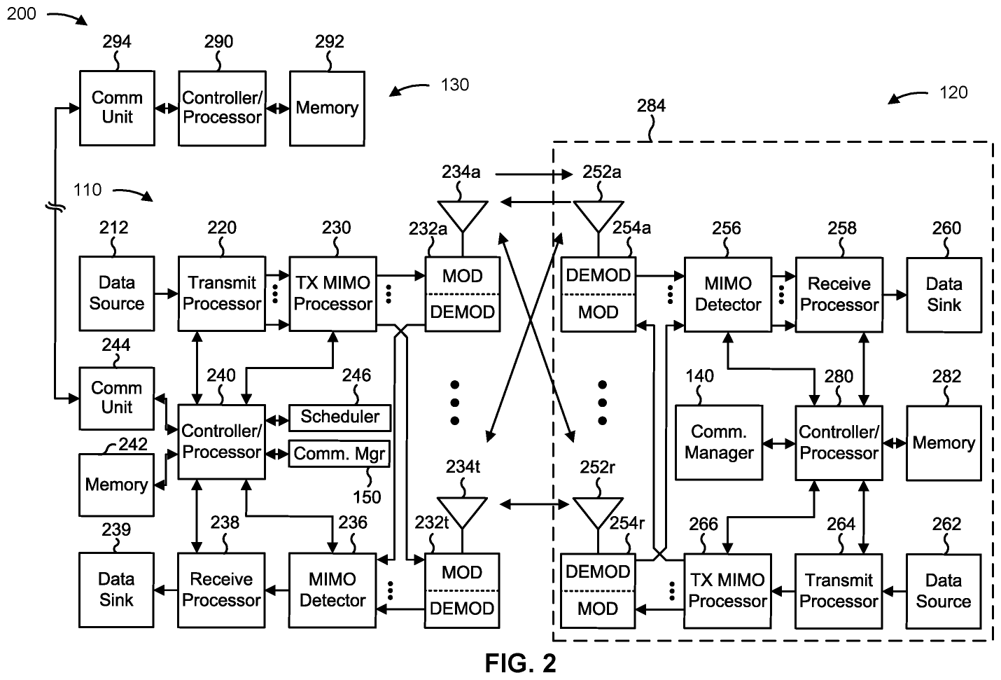

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

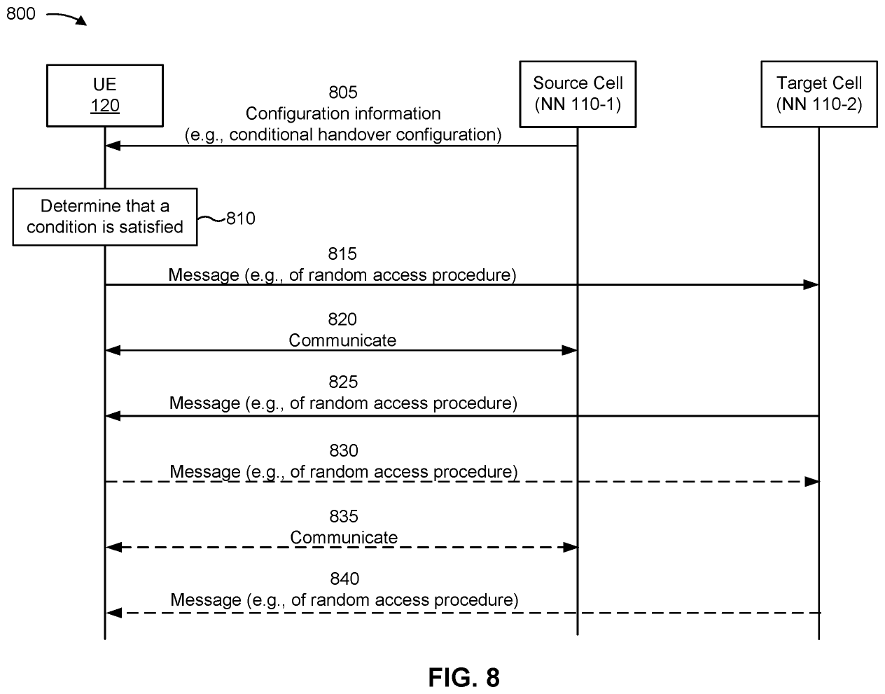

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 8-12).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 8-12).

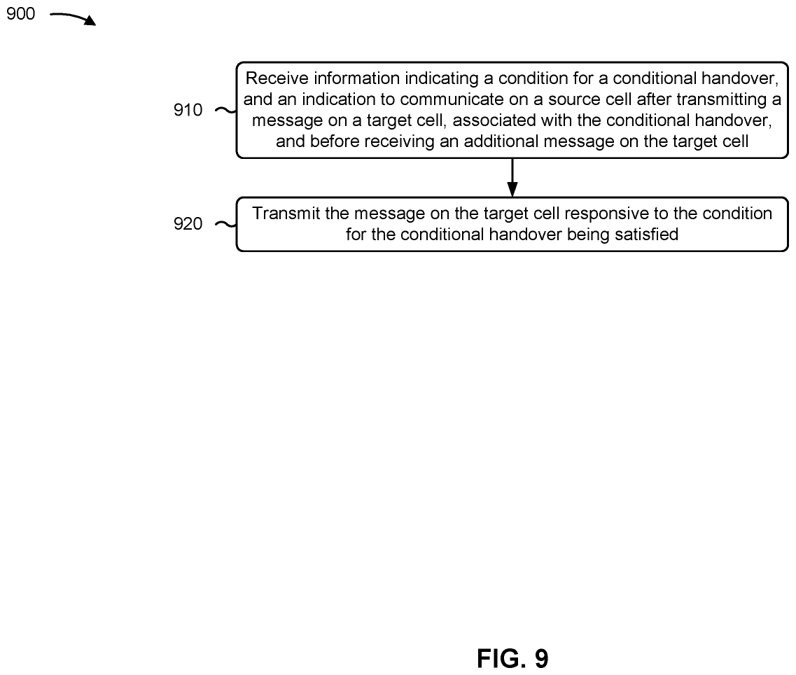

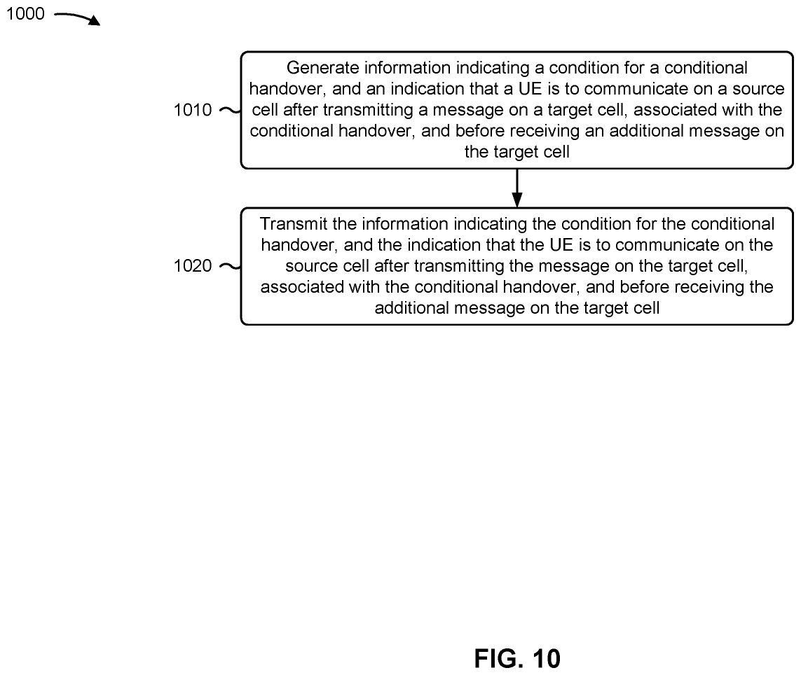

The controller/processor 240 of the network node 110, the controller/processor 280 of the UE 120, and/or any other component(s) of FIG. 2 may perform one or more techniques associated with maintaining communication on a source cell in a conditional handover, as described in more detail elsewhere herein. For example, the controller/processor 240 of the network node 110, the controller/processor 280 of the UE 120, and/or any other component(s) of FIG. 2 may perform or direct operations of, for example, process 900 of FIG. 9, process 1000 of FIG. 10, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 900 of FIG. 9, process 1000 of FIG. 10, and/or other processes as described herein. In some examples, executing instructions may include running the instructions, converting the instructions, compiling the instructions, and/or interpreting the instructions, among other examples.

In some aspects, the UE 120 includes means for receiving information indicating a condition for a conditional handover, and an indication to communicate on a source cell after transmitting a message on a target cell, associated with the conditional handover, and before receiving an additional message on the target cell; and/or means for transmitting the message on the target cell responsive to the condition for the conditional handover being satisfied. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for generating information indicating a condition for a conditional handover, and an indication that a UE is to communicate on a source cell after transmitting a message on a target cell, associated with the conditional handover, and before receiving an additional message on the target cell; and/or means for transmitting the information indicating the condition for the conditional handover, and the indication that the UE is to communicate on the source cell after transmitting the message on the target cell, associated with the conditional handover, and before receiving the additional message on the target cell. The means for the network node 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

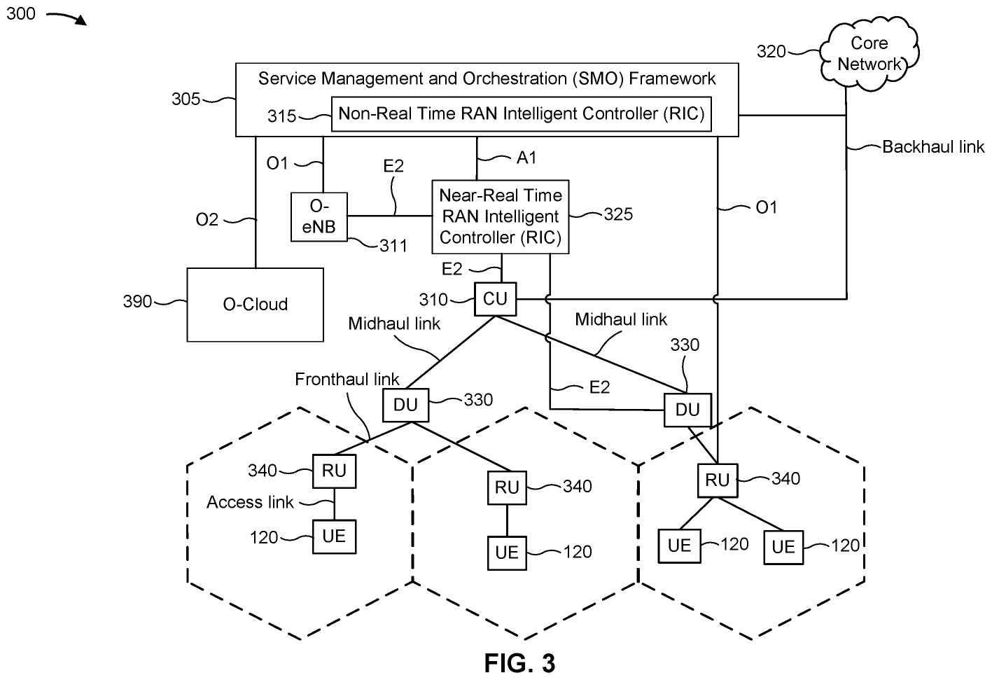

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT MC 325 via an E2 link, or a Non-RT MC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit—User Plane (CU-UP) functionality), control plane functionality (for example, Central Unit—Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a MAC layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

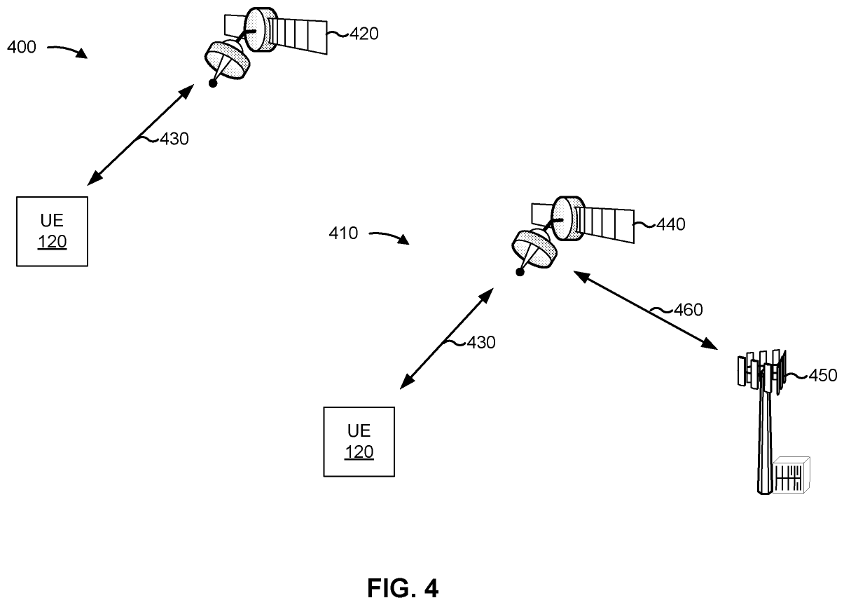

FIG. 4 is a diagram illustrating an example 400 of a regenerative satellite deployment and an example 410 of a transparent satellite deployment in a non-terrestrial network (NTN), in accordance with the present disclosure.

Example 400 shows a regenerative satellite deployment. In example 400, a UE 120 is served by a satellite 420 (e.g., a network device that the UE 120 connects to over the air) via a service link 430. For example, the satellite 420 may include a network node 110 (e.g., network node 110a), such as a gNB. In some examples, the satellite 420 may be referred to as a non-terrestrial base station, a regenerative repeater, or an on-board processing repeater. In some examples, the satellite 420 may demodulate an uplink radio frequency signal, and may modulate a baseband signal derived from the uplink radio signal to produce a downlink radio frequency transmission. The satellite 420 may transmit the downlink radio frequency signal on the service link 430. The satellite 420 may provide a cell that covers the UE 120. The satellite 420 may be a conventional satellite, a balloon, a drone, or the like.

Example 410 shows a transparent satellite deployment, which may also be referred to as a bent-pipe satellite deployment. In example 410, a UE 120 is served by a satellite 440 (e.g., a network device that the UE 120 connects to over the air) via the service link 430. The satellite 440 may be a transparent satellite. The satellite 440 may relay a signal received from gateway 450 via a feeder link 460 and/or from the UE 120 via a service link 430. For example, the satellite 440 may receive an uplink radio frequency transmission from the UE 120, and may transmit a radio frequency transmission without demodulating the uplink radio frequency transmission towards the gateway 450. In some examples, the satellite 440 may frequency convert the uplink radio frequency transmission received on the service link 430 to a frequency of the uplink radio frequency transmission on the feeder link 460, and may amplify and/or filter the uplink radio frequency transmission. In some examples, the UEs 120 shown in example 400 and example 410 may be associated with a Global Navigation Satellite System (GNSS) capability or a Global Positioning System (GPS) capability, though not all UEs have such capabilities. The satellite 440 may provide a cell that covers the UE 120. The satellite 440 may be a conventional satellite, a balloon, a drone, or the like.

The service link 430 may include a link between the satellite 440 and the UE 120, and may include one or more of an uplink or a downlink. The feeder link 460 may include a link between the satellite 440 and the gateway 450, and may include one or more of an uplink (e.g., from the UE 120 to the gateway 450) or a downlink (e.g., from the gateway 450 to the UE 120).

The feeder link 460 and the service link 430 may each experience Doppler effects due to the movement of the satellites 420 and 440, and potentially movement of a UE 120. These Doppler effects may be significantly larger than in a terrestrial network. The Doppler effect on the feeder link 460 may be compensated for to some degree, but may still be associated with some amount of uncompensated frequency error. Furthermore, the gateway 450 may be associated with a residual frequency error, and/or the satellite 420 or 440 may be associated with an on-board frequency error. These sources of frequency error may cause a received downlink frequency at the UE 120 to drift from a target downlink frequency.

An NTN may provide cellular service coverage to areas where terrestrial cellular service is not available. Due to the fast movement of satellites (e.g., that are in low-Earth orbit (LEO)) of the NTN, conditional handover (CHO) may be used for mobility support in the NTN. The NTN may support conditional handover according to techniques designed for a terrestrial network. For example, conditional handover may be based on a measurement associated with a neighbor cell becoming better than a measurement associated with a serving cell by an offset (referred to as an “A3” event) or may be based on a measurement associated with a neighbor cell becoming better than a first threshold and a measurement associated with a serving cell becoming worse than a second threshold (referred to as an “A5” event). Moreover, conditional handover may be based on a measurement associated with a neighbor cell becoming better than a threshold (referred to as an “A4” event), may be timer-based, or may be location-based (e.g., as described in 3GPP Technical Specification (TS) 38.331).

As indicated above, FIG. 4 is provided as an example. Other examples may differ from what is described with regard to FIG. 4.

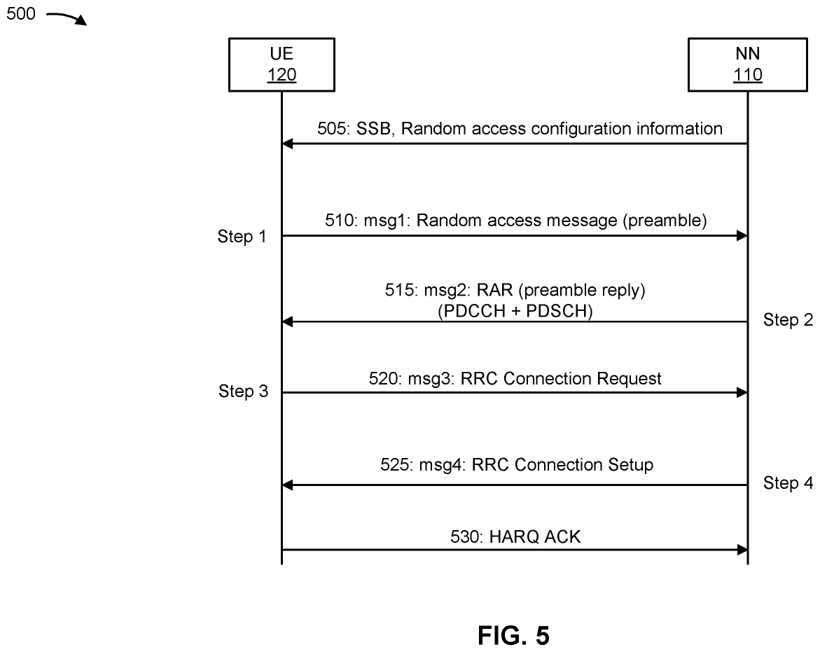

FIG. 5 is a diagram illustrating an example 500 of a four-step random access procedure, in accordance with the present disclosure. As shown in FIG. 5, a network node 110 and a UE 120 may communicate with one another to perform the four-step random access procedure, in accordance with the present disclosure.

As shown by reference number 505, the network node 110 may transmit, and the UE 120 may receive, one or more synchronization signal blocks (SSBs) and random access configuration information. In some aspects, the random access configuration information may be transmitted in and/or indicated by system information (e.g., in one or more system information blocks (SIBs)) and/or an SSB, such as for contention-based random access (CBRA). Additionally, or alternatively, the random access configuration information may be transmitted in an RRC message and/or a physical downlink control channel (PDCCH) order message that triggers a random access procedure, such as for contention-free random access (CFRA). The random access configuration information may include one or more parameters to be used in the random access procedure, such as one or more parameters for transmitting a random access message (RAM) and/or one or more parameters for receiving a random access response (RAR).

As shown by reference number 510, the UE 120 may transmit an RAM, which may include a preamble (sometimes referred to as a random access preamble, a random access channel (RACH) preamble, a physical random access channel (PRACH) preamble, or a RAM preamble). The message that includes the preamble may be referred to as a message 1, msg1, MSG1, a first message, or an initial message in a four-step random access procedure. The random access message may include a random access preamble identifier.

As shown by reference number 515, the network node 110 may transmit an RAR as a reply to the preamble. The message that includes the RAR may be referred to as message 2, msg2, MSG2, or a second message in a four-step random access procedure. In some aspects, the RAR may indicate the detected random access preamble identifier (e.g., received from the UE 120 in msg1). Additionally, or alternatively, the RAR may indicate a resource allocation to be used by the UE 120 to transmit a third message of the random access procedure.

In some aspects, as part of the second step of the four-step random access procedure, the network node 110 may transmit a PDCCH communication for the RAR. The PDCCH communication may schedule a physical downlink shared channel (PDSCH) communication that includes the RAR. For example, the PDCCH communication may indicate a resource allocation for the PDSCH communication. Also as part of the second step of the four-step random access procedure, the network node 110 may transmit the PDSCH communication for the RAR, as scheduled by the PDCCH communication. The RAR may be included in a medium access control (MAC) protocol data unit (PDU) of the PDSCH communication.

As shown by reference number 520, the UE 120 may transmit an RRC connection request message. The RRC connection request message may be referred to as message 3, msg3, MSG3, or a third message of the four-step random access procedure. In some aspects, the RRC connection request may include a UE identifier, uplink control information (UCI), and/or a physical uplink shared channel (PUSCH) communication (e.g., an RRC connection request). For example, the RRC connection request message may be the uplink transmission scheduled by the RAR, and may contain a cell radio network temporary identifier (C-RNTI) associated with the UE 120.

As shown by reference number 525, the network node 110 may transmit an RRC connection setup message. The RRC connection setup message may be referred to as message 4, msg4, MSG4, or a fourth message of the four-step random access procedure. In some aspects, the RRC connection setup message may include the detected UE identifier, a timing advance value, and/or contention resolution information. As shown by reference number 530, if the UE 120 successfully receives the RRC connection setup message, the UE 120 may transmit a hybrid automatic repeat request (HARQ) acknowledgment (ACK). In some aspects, the UE 120 may use the four-step random access procedure when attaching to a new cell in connection with a conditional handover to the new cell from a source cell.

As indicated above, FIG. 5 is provided as an example. Other examples may differ from what is described with regard to FIG. 5.

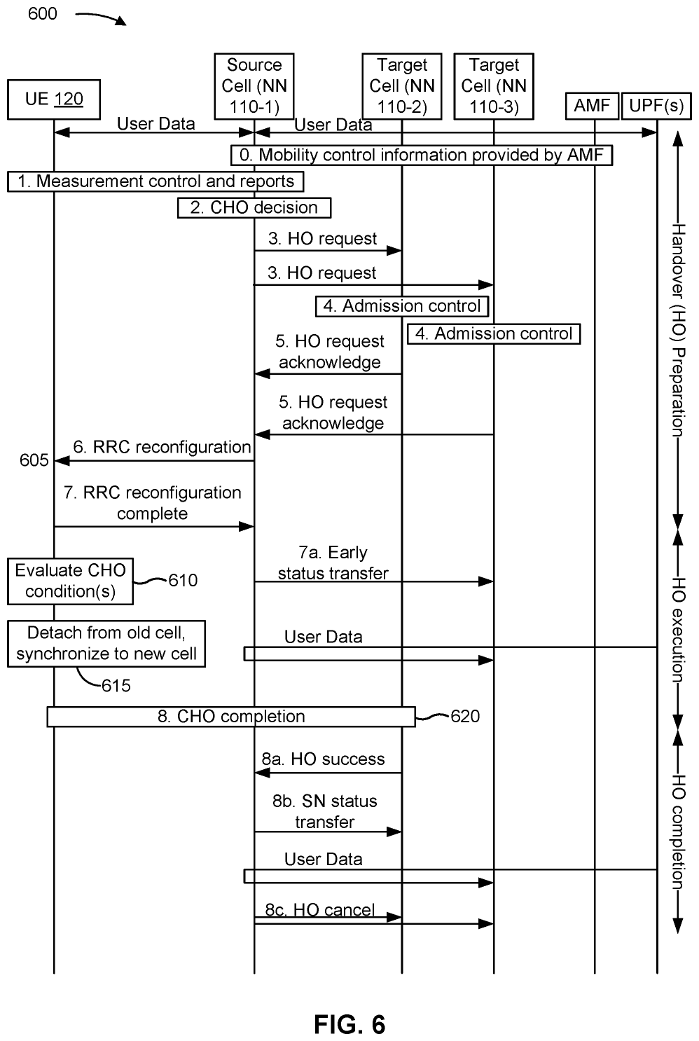

FIG. 6 is a diagram illustrating an example 600 of conditional handover, in accordance with the present disclosure. As shown, example 600 may include communication between a UE 120, a network node 110-1 serving a source cell, a network node 110-2 serving a target cell, a network node 110-3 serving an additional target cell, and one or more entities of a core network, such as an access and mobility management function (AMF) entity and one or more user plane function (UPF) entities.

As shown by reference number 605, the network node 110-1 (associated with the source cell) may transmit, and the UE 120 may receive, a message (e.g., an RRC reconfiguration message) indicating a conditional handover configuration. For example, the message may indicate configurations of the candidate target cells and/or the message may include information indicating one or more conditions for executing conditional handover. As shown by reference number 610, the UE 120 may evaluate the one or more conditions. If at least one candidate target cell satisfies a condition, as shown by reference number 615, the UE 120 may detach from the network node 110-1 (associated with the source cell), apply the configuration for that target cell, and synchronize to that target cell. After the UE 120 detaches from the network node 110-1, the UE 120 may not monitor for downlink transmissions from the network node 110-1. As shown by reference number 620, the UE 120 may transmit, and the network node 110-2 (associated with the target cell for the handover of the UE 120) may receive, a message (e.g., an RRC reconfiguration complete message) indicating completion of the handover procedure.

As indicated above, FIG. 6 is provided as an example. Other examples may differ from what is described with regard to FIG. 6.

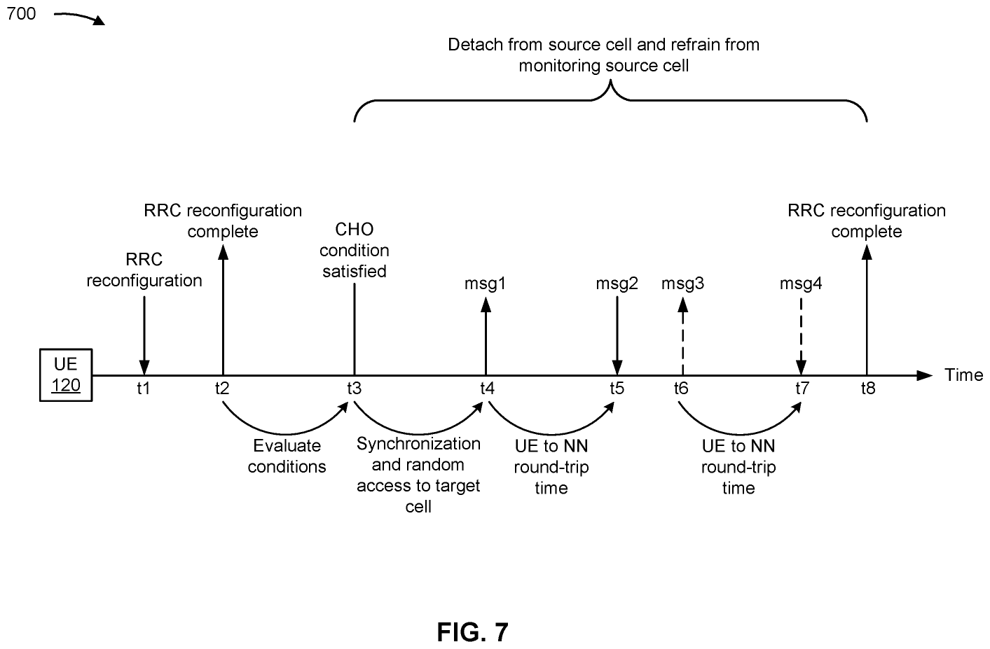

FIG. 7 is a diagram illustrating an example 700 of a conditional handover timeline, in accordance with the present disclosure. The conditional handover timeline is shown from the perspective of a UE 120. As shown, at a first time t1, the UE 120 may receive an RRC reconfiguration message that indicates a conditional handover configuration. The conditional handover configuration may indicate configurations for candidate cells and/or information indicating one or more conditional handover execution conditions, as described in connection with reference number 605 of FIG. 6. At a second time t2, the UE 120 may transmit an RRC reconfiguration complete message indicating that the UE 120 has configured itself in accordance with the conditional handover configuration.

Between t2 and a third time t3, the UE 120 may evaluate whether a candidate cell satisfies a conditional handover condition, as described in connection with reference number 610 of FIG. 6. At t3, the UE 120 may determine that a condition has been satisfied by a candidate cell served by a target network node. Between t3 and a fourth time t4, the UE 120 may detach from a source cell served by a source network node, synchronize with the candidate cell, and initiate a random access procedure.

At t4, the UE 120 may transmit a first message (msg1) of the random access procedure to the target network node. At a fifth time t5, the UE 120 may receive a second message (msg2) of the random access procedure from the target network node. A minimum delay between the UE 120 transmitting the first message at t4 and receiving the second message at t5 may correspond to a round-trip time between the UE 120 and the target network node.

In some examples, at a sixth time t6, the UE 120 may transmit a third message (msg3) of the random access procedure to the target network node. In some examples, at a seventh time t7, the UE 120 may receive a fourth message (msg4) of the random access procedure from the target network node. The UE 120 may transmit the third message and receive the fourth message in CBRA. In CFRA, the third message and the fourth message may not be used. At an eighth time t8, the UE 120 may transmit an RRC reconfiguration complete message to the target network node to indicate completion of the random access procedure, as described in connection with reference number 620 of FIG. 6.

In an NTN, there may be a large round-trip time between the UE 120 and the target network node (e.g., from t4 to t5 and/or from t6 to t7) due to high propagation delay (e.g., tens of milliseconds for LEO satellites and some medium earth orbit (MEO) satellites, and hundreds of milliseconds for some MEO satellites and geostationary earth orbit (GEO) satellites). Thus, a minimum time between t3 when the UE 120 transmits the first message and t4 when the UE 120 receives the second message may correspond to the round-trip time. Similarly, a minimum time between t6 when the UE 120 transmits the third message and t7 when the UE 120 receives the fourth message may correspond to the round-trip time.

When the conditional handover condition is met at t3, the UE 120 may autonomously detach from the source network node and access the target network node. As shown, after detaching from the source network node at t3, the UE 120 may not monitor for downlink transmissions from the source network node. However, the source network node may continue downlink transmissions to the UE 120 without knowing that the UE 120 has stopped monitoring for downlink transmissions from the source network node. For example, in an NTN, the UE 120 may not provide HARQ feedback, and therefore the source network node may be unable to detect that the UE 120 is not receiving downlink transmissions. Accordingly, during the round-trip time for communications between the UE 120 and the target network node, the source network node may perform downlink transmissions to the UE 120.

For an RLC acknowledged mode (AM) radio bearer, downlink packets transmitted to the UE 120 by the source network node during t3 to t8 may be retransmitted to the UE 120 by the target network node after the UE 120 connects to the target network node (e.g., based at least in part on a status report transmitted by the UE 120 and/or the source network node to the target network node). Thus, the source network node may consume computing resources and network resources to transmit downlink packets that are not being monitored for by the UE 120. For an RLC unacknowledged mode (UM) radio bearer, the downlink packets transmitted to the UE 120 by the source network node during t3 to t8 may not be retransmitted to the UE 120 by the target network node, thereby resulting in lost packets and impacting a performance of communications at the UE 120. Due to the large round-trip time associated with an NTN, the resources consumed by the source network node to transmit the downlink packets that are unmonitored and/or the quantity of lost downlink packets may be excessive.

In some aspects, upon initiating conditional handover (e.g., responsive to satisfaction of a conditional handover condition), the UE 120 may transmit, to the source network node, an indication that the UE 120 is performing the conditional handover to the target network node. This indication, as well as signaling to schedule the indication, may also be subject to a long round-trip time in an NTN. In some cases, there may be no mechanism for the UE 120 to ensure that the indication was received by the source network node.

Some techniques and apparatuses described herein enable a UE to maintain communications with a source network node (that serves a source cell), in connection with a conditional handover, during a round-trip time associated with messages (e.g., random access messages) between the UE and a target network node (that serves a target cell). For example, the UE may communicate on the source cell (e.g., to receive downlink transmissions) after the UE transmits a random access message on the target cell and while waiting for a response to the random access message on the target cell. In this way, the UE may monitor and receive downlink transmissions on the source cell while waiting for the response on the target cell. Accordingly, processing resources and/or network resources used by the source network node are efficiently utilized and packet loss at the UE is reduced, thereby improving a performance of communications at the UE.

As indicated above, FIG. 7 is provided as an example. Other examples may differ from what is described with regard to FIG. 7.

FIG. 8 is a diagram of an example 800 associated with maintaining communication on a source cell in conditional handover, in accordance with the present disclosure. As shown in FIG. 8, a source cell of the UE 120 may be served by a network node 110-1, and a target cell (e.g., a candidate target cell) of the UE 120 may be served by a network node 110-2. The network nodes 110-1, 110-2 may include one or more CUs, one or more DUs, and/or one or more RUs, among other examples. The UE 120, the network node 110-1, and the network node 110-2 may be part of a wireless network. For example, the UE 120, the network node 110-1, and the network node 110-2 may be part of an NTN network. As an example, the network nodes 110-1, 110-2 may be one or more entities of one or more satellites or one or more gateways, as described in connection with FIG. 4. The UE and the network node 110-1 may have established a wireless connection prior to operations shown in FIG. 8.

As shown by reference number 805, the network node 110-1 may transmit (e.g., provide or output), and the UE 120 may receive, configuration information. In some aspects, the UE 120 may receive the configuration information via one or more of a system information block (SIB), RRC signaling, one or more MAC control elements (MAC-CEs), and/or downlink control information (DCI), among other examples. For example, the configuration information may be indicated in an RRC reconfiguration message. In some aspects, the configuration information may include an indication of one or more configuration parameters (e.g., already known to the UE 120 and/or previously indicated by the network node 110-1 or other network device) for selection by the UE, and/or explicit configuration information for the UE 120 to use to configure the UE 120, among other examples.

In some aspects, the configuration information may indicate configurations for one or more candidate cells, such as the target cell. For example, a configuration for a candidate cell may be used by the UE 120 to connect to the candidate cell in a conditional handover. Additionally, or alternatively, the configuration information may include information indicating one or more conditions for a conditional handover. For example, a condition for the conditional handover may be an A3 event, an A4 event, and/or an A5 event, among other examples, as described herein. Additionally, or alternatively, the configuration information may include an indication that the UE 120 is to communicate on the source cell after transmitting a message (e.g., a message of a random access procedure) on the target cell (e.g., in connection with conditional handover to the target cell) and before receiving an additional message (e.g., a response message of the random access procedure) on the target cell. In other words, the indication may indicate that the UE 120 is to communicate on the source cell in between communications (e.g., random access communications) on the target cell (e.g., during at least a portion of a round trip time between the UE 120 and the network node 110-2, associated with the target cell, from when the message on the target cell is transmitted).

In some aspects, the UE 120 may receive the configurations for the candidate cells, the information indicating the conditions for conditional handover, and the indication that the UE 120 is to communicate on the source cell in separate communications from the network node 110-1. For example, the UE 120 may receive the configurations for the candidate cells and the information indicating the conditions for conditional handover by a SIB and/or RRC signaling, and the UE 120 may receive the indication that the UE 120 is to communicate on the source cell in DCI, in a MAC-CE, in a SIB, and/or in separate RRC signaling. In some aspects, the UE 120 may receive the indication that the UE 120 is to communicate on the source cell from the network node 110-2.

In some aspects, the indication that the UE 120 is to communicate on the source cell may be an explicit indication that the UE 120 is to communicate on the source cell (e.g., the indication may indicate whether or not the UE 120 is to communicate on the source cell). Here, the indication may be based at least in part on a type of a satellite used for communicating on the target cell, ephemeris information associated with the satellite used for communicating on the target cell, a reported location of the UE 120 (e.g., as reported by the UE 120), and/or information relating to traffic at the UE 120 (e.g., whether the UE 120 has data to transmit) and quality of service (QoS) requirements at the UE 120, among other examples. In other words, the network node 110-1 may determine to provide the indication that the UE 120 is to communicate on the source cell based at least in part on the type of the satellite, the ephemeris information, the reported location, and/or the information relating to traffic and QoS, among other examples.

In some aspects, the UE 120 may receive multiple indications that the UE 120 is to communicate on the source cell (e.g., the indication is one of multiple indications). Each indication may be associated with a respective candidate target cell and/or a respective conditional handover event. For example, if a particular conditional handover event occurs, or if a particular candidate target cell satisfies a conditional handover condition, then the UE 120 may apply the indication that is associated with that conditional handover event or that candidate target cell.

In some aspects, the indication that the UE 120 is to communicate on the source cell may indicate at least one condition (e.g., an additional condition from the condition(s) for conditional handover) for communicating on the source cell (e.g., the UE 120 is to communicate on the source cell only if the condition is satisfied). In some aspects, the UE 120 may be provisioned (e.g., pre-configured) with information indicating the condition.

The condition may relate to a round-trip time between the UE 120 and the network node 110-2 associated with the target cell (e.g., the condition may indicate that the UE 120 is to communicate on the source cell if the round-trip time satisfies a threshold). For example, if the round-trip time is longer than a threshold (e.g., that is configured for the UE 120), then the UE 120 may communicate on the source cell (e.g., because there may a long delay from when the UE 120 transmits a random access message to the network node 110-2 and when the UE 120 receives a responsive random access message from the network node 110-2). Additionally, or alternatively, the condition may relate to a type of a satellite (e.g., an LEO, an MEO, or a GEO satellite) used for communicating on the target cell (e.g., the condition may indicate that the UE 120 is to communicate on the source cell if the type of the satellite is one or more particular types). For example, if the target cell uses a GEO satellite (e.g., that is associated with a relatively long round-trip time), then the UE 120 may communicate on the source cell.

Additionally, or alternatively, the condition may relate to a configuration of the UE 120 (e.g., the condition may indicate that the UE 120 is to communicate on the source cell if the UE 120 has a particular configuration for one or more parameters, such as a HARQ feedback parameter). For example, if HARQ feedback for all downlink HARQ processes is disabled for the UE 120, then the UE 120 may communicate on the source cell. Additionally, or alternatively, the condition may relate to a measurement performed by the UE 120 (e.g., the condition may indicate that the UE 120 is to communicate on the source cell if the measurement satisfies a threshold or a condition). For example, if a measurement of the source cell satisfies a particular condition (e.g., an RSRP of the source cell is greater than a threshold), then the UE 120 may communicate on the source cell. In this way, processing resources and/or network resources associated with transmissions on the source cell may be conserved. Additionally, or alternatively, the condition may relate to a condition and/or event (e.g., one of the conditions and/or events that is configured for the UE 120) for the conditional handover (e.g., the condition may indicate that the UE 120 is to communicate on the source cell only if the condition for conditional handover relates to a particular type of handover event). For example, if the condition and/or event for triggering and executing the conditional handover relates to a particular handover event, such as an A4 event, then the UE 120 may communicate on the source cell.

Prior to transmitting the configuration information, the network node 110-1 and/or the network node 110-2 may generate the configuration information. For example, the network node 110-1 and/or the network node 110-2 may generate the information indicating the condition(s) for conditional handover, and/or the network node 110-1 and/or the network node 110-2 may generate the indication that the UE 120 is to communicate on the source cell. To generate the information and/or the indication, the network node 110-1 and/or the network node 110-2 may encode and/or modulate (e.g., using an MCS) data (e.g., the information and/or the indication) for the UE 120. In some aspects, the network node 110-2 may generate the configuration information, and the configuration information may be transmitted to the UE 120 via the network node 110-1, or vice versa.

The UE 120 may configure itself based at least in part on the configuration information. In some aspects, the UE 120 may be configured to perform one or more operations described herein based at least in part on the configuration information. Additionally or alternatively, the UE 120 may be configured to perform one or more operations described herein based at least in part on information provisioned (e.g., pre-configured) for the UE 120.

The UE 120 may monitor (e.g., evaluate) the one or more conditions for the conditional handover after receiving the information indicating the one or more conditions. For example, the UE 120 may perform measurements of the source cell and/or one or more candidate cells, such as the target cell, to determine whether one or more measurements satisfy a condition, and/or trigger an event, for the conditional handover.

As shown by reference number 810, the UE 120 may determine that a condition for the conditional handover is satisfied. For example, the UE 120 may determine that the target cell satisfies the condition for the conditional handover. Accordingly, the conditional handover of the UE 120 may be to the target cell. In some aspects, responsive to the condition for conditional handover being satisfied and/or responsive to the UE 120 applying the configuration for the target cell, the UE 120 may store first information relating to communicating on the source cell (e.g., relating to the source cell's downlink and/or uplink). For example, the information may indicate a frequency shift associated with the source cell, slot timing information associated with the source cell, or the like. In some aspects, the UE 120 may initiate execution of the conditional handover by synchronizing to the target cell. In some aspects, responsive to initiating execution of the conditional handover (e.g., synchronizing to the target cell and/or transmitting a random access-related message on the target cell, such as described at reference number 815), the UE 120 may store second information relating to communicating on the target cell (e.g., relating to the target cell's downlink and/or uplink). For example, the second information may indicate a frequency shift associated with the target cell, slot timing information associated with the target cell, or the like.

In some aspects, the UE 120 may store (e.g., upon switching from the source cell to the target cell) the first information in association with (e.g., together with) first ephemeris-related information associated with the source cell, and/or the UE 120 may store (e.g., upon switching from the target cell to the source cell; “source” and “target” are used here for clarity, and in practice, the cells may have the opposite designations) the second information in association with (e.g., together with) second ephemeris-related information associated with the target cell. This stored information/associations may be used by the UE 120 for fast switching between cells (e.g., the information/associations may be used by the UE 120 to derive time domain and/or frequency domain resource information for transmission and/or reception).

In some aspects, responsive to the condition for conditional handover being satisfied and/or responsive to initiating execution of the conditional handover, the UE 120 may refrain from resetting a MAC entity associated with the source cell and/or refrain from re-establishing an RLC entity associated with the source cell. This may enable the UE 120 to communicate on the source cell in between communications (e.g., random access communications) on the target cell. In some aspects, the UE 120 may set a new MAC entity and/or establish a new RLC entity associated with the target cell without resetting the MAC entity and/or reestablishing the RLC entity associated with the source cell.

As shown by reference number 815, the UE 120 may transmit, and the network node 110-2 may receive (e.g., obtain), a message on the target cell. The UE 120 may transmit the message on the target cell responsive to the condition for the conditional handover being satisfied. The message may be associated with a random access procedure for the target cell. For example, the message may be a first message of the random access procedure, a third message of the random access procedure, or an RRC reconfiguration completion message (e.g., denoted as a “fifth message”), as described herein. As described herein, there may be a long delay between when the UE 120 transmits the message to the network node 110-2 (at a time t) and when the UE 120 receives a responsive message from the network node 110-2 (at a time t+a round-trip time between the UE 120 and the network node 110-2). During this time, the network node 110-1 may be unaware of the conditional handover of the UE 120 to the target cell, and may continue downlink transmissions to the UE 120.

As shown by reference number 820, the UE 120, and the network node 110-1, may communicate on the source cell after the UE 120 transmits the message on the target cell and before the UE 120 receives a responsive message on the target cell. For example, the UE 120 may communicate on the source cell in accordance with the indication described in connection with reference number 805. In particular, the UE 120 may communicate on the source cell if the indication explicitly indicates that the UE 120 is to communicate on the source cell, or the UE 120 may communicate on the source cell if a condition for communicating on the source cell, indicated by the indication, is satisfied. Communicating on the source cell may include downlink reception at the UE 120 and/or uplink transmission by the UE 120. For example, communicating on the source cell may include both downlink reception at the UE 120 and uplink transmission by the UE 120. In some aspects, to communicate on the source cell, the UE 120 may monitor for downlink transmissions on the source cell.

The UE 120 may communicate on the source cell during at least a portion of the round-trip time, between the UE 120 and the network node 110-2, from when the message on the target cell is transmitted by the UE 120. For example, the UE 120 may communicate on the source cell during at least a portion of a time period from time t to time t+a round-trip time between the UE 120 and the network node 110-2. In some aspects, the UE 120 may determine (e.g., calculate) the round-trip time between the UE 120 and the network node 110-2 based at least in part on ephemeris information and/or a set of common timing advance parameters associated with a satellite for the target cell (e.g., which may be provided in the configuration information with the conditional handover configuration and/or in a SIB broadcasted on the target cell), a Kmac timing parameter (e.g., indicating a feeder link round-trip delay between an uplink slot at the network node 110-2 and a corresponding downlink slot at the network node 110-2), and/or a location of the UE 120.

To communicate on the source cell, after transmitting the message on the target cell, the UE 120 may switch from communicating on the target cell to communicating on the source cell. To communicate on the source cell, the UE 120 may use the first information, relating to communicating on the source cell, stored by the UE 120.

As shown by reference number 825, the network node 110-2 may transmit (e.g., provide or output), and the UE 120 may receive, an additional message on the target cell. The additional message may also be associated with the random access procedure for the target cell. For example, the additional message may be a second message of the random access procedure, a fourth message of the random access procedure, or a downlink communication (e.g., the first downlink communication to the UE 120, or the “sixth message,” after receiving the fifth message described above), as described herein. The additional message may be in response to the message transmitted by the UE 120. For example, if the message transmitted by the UE 120 is the first message of the random access procedure, the additional message may be the second message of the random access procedure.

To receive the additional message, the UE 120 may switch from communicating on the source cell to communicating on the target cell. For example, the UE 120 may switch to communicating on the target cell at (e.g., upon, or immediately prior to, the expiration of) the round-trip time between the UE 120 and the network node 110-2. To communicate on the target cell, the UE 120 may use the second information, relating to communicating on the target cell, stored by the UE 120.

The UE 120 may switch between communicating with the target cell and communicating with the source cell one or more times (e.g., multiple times). For example, as shown by reference number 830, the UE 120 may transmit, and the network node 110-2 may receive (e.g., obtain), a further message on the target cell, in a similar manner as described above. As an example, if the message transmitted by the UE 120 at reference number 815 is the first message of the random access procedure and the additional message received by the UE 120 at reference number 825 is the second message of the random access procedure, then the further message transmitted by the UE 120 at reference number 830 may be a third or a fifth message of the random access procedure.

As shown by reference number 835, the UE 120, and the network node 110-1, may communicate on the source cell after the UE 120 transmits the further message on the target cell and before the UE 120 receives a responsive message on the target cell, in a similar manner as described above. For example, the UE 120 may communicate on the source cell in accordance with the indication described in connection with reference number 805. As shown by reference number 840, the network node 110-2 may transmit (e.g., provide or output), and the UE 120 may receive, another message on the target cell, in a similar manner as described above. For example, if the further message transmitted by the UE 120 at reference number 830 is the third or the fifth message of the random access procedure, then the message received by the UE 120 at reference number 840 may be the fourth or the sixth message, respectively, of the random access procedure.

In this way, the UE 120 may communicate on the source cell after transmitting a random access message on the target cell and while waiting to receive a responsive message on the target cell. Accordingly, the UE 120 may receive downlink transmissions on the source cell that would otherwise need to be retransmitted on the target cell following completion of the random access procedure, or that would otherwise be lost. Thus, techniques described herein conserve computing resources and/or network resources, as well as improve the performance of communications at the UE 120.

As indicated above, FIG. 8 is provided as an example. Other examples may differ from what is described with respect to FIG. 8.

FIG. 9 is a diagram illustrating an example process 900 performed, for example, by a UE, in accordance with the present disclosure. Example process 900 is an example where the UE (e.g., UE 120) performs operations associated with maintaining communication on a source cell in a conditional handover.

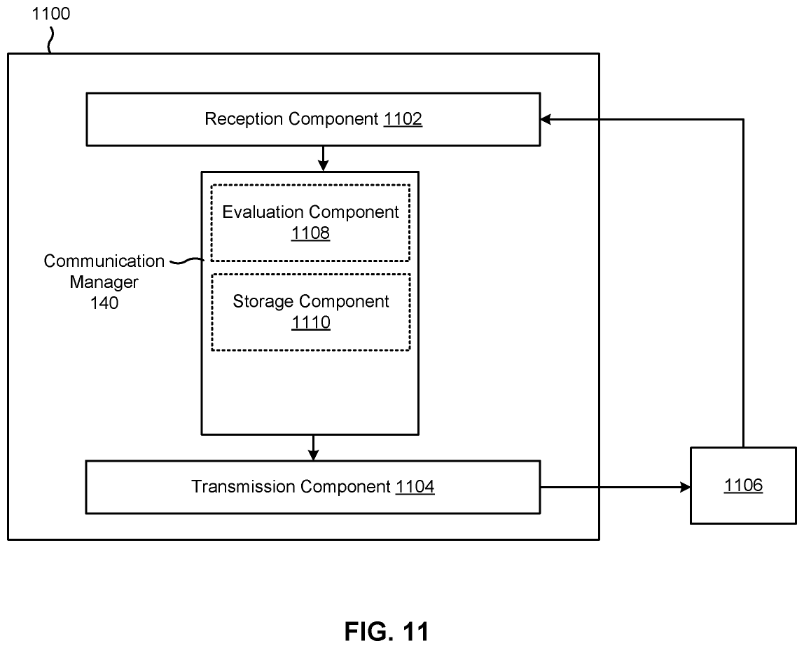

As shown in FIG. 9, in some aspects, process 900 may include receiving information indicating a condition for a conditional handover, and an indication to communicate on a source cell after transmitting a message on a target cell, associated with the conditional handover, and before receiving an additional message on the target cell (block 910). For example, the UE (e.g., using communication manager 140 and/or reception component 1102, depicted in FIG. 11) may receive information indicating a condition for a conditional handover, and an indication to communicate on a source cell after transmitting a message on a target cell, associated with the conditional handover, and before receiving an additional message on the target cell, as described above.

As further shown in FIG. 9, in some aspects, process 900 may include transmitting the message on the target cell responsive to the condition for the conditional handover being satisfied (block 920). For example, the UE (e.g., using communication manager 140 and/or transmission component 1104, depicted in FIG. 11) may transmit the message on the target cell responsive to the condition for the conditional handover being satisfied, as described above.

Process 900 may include additional aspects, such as any single aspect or any combination of aspects described below and/or in connection with one or more other processes described elsewhere herein.

In a first aspect, process 900 includes communicating on the source cell, in accordance with the indication, after transmitting the message on the target cell and before receiving the additional message on the target cell.

In a second aspect, alone or in combination with the first aspect, communicating on the source cell is during at least a portion of a round trip time, between the UE and a network node associated with the target cell, from the message on the target cell being transmitted.

In a third aspect, alone or in combination with one or more of the first and second aspects, the indication indicates an additional condition for communicating on the source cell.

In a fourth aspect, alone or in combination with one or more of the first through third aspects, the additional condition relates to one or more of a round-trip time between the UE and a network node associated with the target cell, a type of a satellite used for communicating on the target cell, a configuration of the UE, a measurement performed by the UE, or the condition for the conditional handover.

In a fifth aspect, alone or in combination with one or more of the first through fourth aspects, the indication is based at least in part on one or more of a type of a satellite used for communicating on the target cell, information associated with the satellite, a reported location of the UE, or information relating to traffic and QoS requirements at the UE.

In a sixth aspect, alone or in combination with one or more of the first through fifth aspects, the indication is one of multiple indications, and each of the multiple indications is associated with at least one of a respective candidate target cell or a respective conditional handover event.

In a seventh aspect, alone or in combination with one or more of the first through sixth aspects, process 900 includes storing at least one of first information relating to communicating on the source cell or second information relating to communicating on the target cell.

In an eighth aspect, alone or in combination with one or more of the first through seventh aspects, the first information is stored in association with first ephemeris information associated with the source cell, or the second information is stored in association with second ephemeris information associated with the target cell.

In a ninth aspect, alone or in combination with one or more of the first through eighth aspects, the message is a first message of a random access procedure, a third message of the random access procedure, or an RRC reconfiguration completion message, and the additional message is a second message of the random access procedure, a fourth message of the random access procedure, or a downlink communication.

In a tenth aspect, alone or in combination with one or more of the first through ninth aspects, process 900 includes refraining from resetting a MAC entity associated with the source cell or re-establishing an RLC entity associated with the source cell.

In an eleventh aspect, alone or in combination with one or more of the first through tenth aspects, the target cell is associated with a non-terrestrial network.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, by a network node, in accordance with the present disclosure. Example process 1000 is an example where the network node (e.g., network node 110) performs operations associated with maintaining communication on a source cell in a conditional handover.

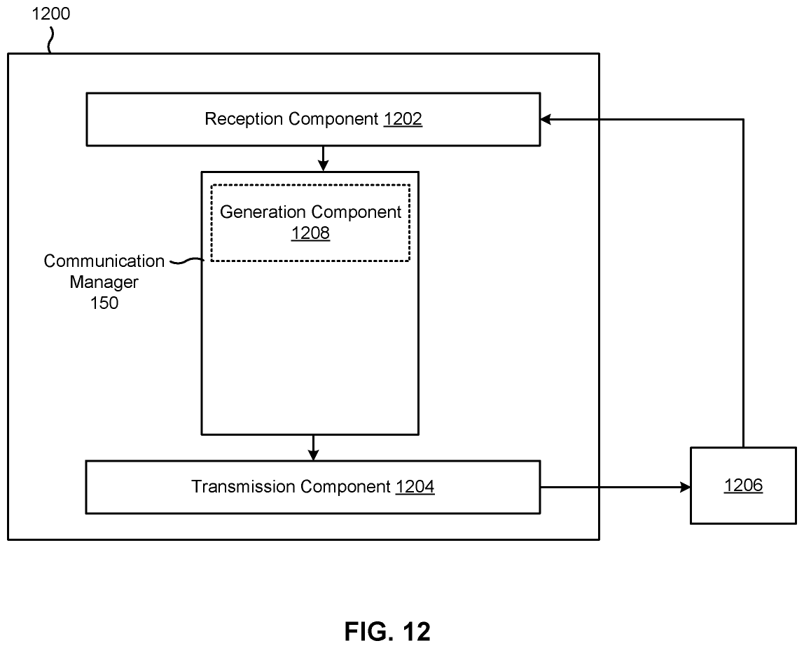

As shown in FIG. 10, in some aspects, process 1000 may include generating information indicating a condition for a conditional handover, and an indication that a UE is to communicate on a source cell after transmitting a message on a target cell, associated with the conditional handover, and before receiving an additional message on the target cell (block 1010). For example, the network node (e.g., using communication manager 150 and/or generation component 1208, depicted in FIG. 12) may generate information indicating a condition for a conditional handover, and an indication that a UE is to communicate on a source cell after transmitting a message on a target cell, associated with the conditional handover, and before receiving an additional message on the target cell, as described above.

As further shown in FIG. 10, in some aspects, process 1000 may include transmitting the information indicating the condition for the conditional handover, and the indication that the UE is to communicate on the source cell after transmitting the message on the target cell, associated with the conditional handover, and before receiving the additional message on the target cell (block 1020). For example, the network node (e.g., using communication manager 150 and/or transmission component 1204, depicted in FIG. 12) may transmit the information indicating the condition for the conditional handover, and the indication that the UE is to communicate on the source cell after transmitting the message on the target cell, associated with the conditional handover, and before receiving the additional message on the target cell, as described above.

Process 1000 may include additional aspects, such as any single aspect or any combination of aspects described below and/or in connection with one or more other processes described elsewhere herein.

In a first aspect, the indication indicates an additional condition for communicating on the source cell.

In a second aspect, alone or in combination with the first aspect, the additional condition relates to one or more of a round-trip time between the UE and a network node associated with the target cell, a type of a satellite used for communicating on the target cell, a configuration of the UE, a measurement performed by the UE, or the condition for the conditional handover.

In a third aspect, alone or in combination with one or more of the first and second aspects, the indication is based at least in part on one or more of a type of a satellite used for communicating on the target cell, information associated with the satellite, a reported location of the UE, or information relating to traffic and QoS requirements at the UE.

In a fourth aspect, alone or in combination with one or more of the first through third aspects, the indication is one of multiple indications, and each of the multiple indications is associated with at least one of a respective candidate target cell or a respective conditional handover event.

In a fifth aspect, alone or in combination with one or more of the first through fourth aspects, the message is a first message of a random access procedure, a third message of the random access procedure, or an RRC reconfiguration completion message, and the additional message is a second message of the random access procedure, a fourth message of the random access procedure, or a downlink communication.

In a sixth aspect, alone or in combination with one or more of the first through fifth aspects, the target cell is associated with a non-terrestrial network.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication, in accordance with the present disclosure. The apparatus 1100 may be a UE, or a UE may include the apparatus 1100. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE, a base station, or another wireless communication device) using the reception component 1102 and the transmission component 1104. As further shown, the apparatus 1100 may include the communication manager 140. The communication manager 140 may include one or more of an evaluation component 1108 or a storage component 1110, among other examples.

In some aspects, the apparatus 1100 may be configured to perform one or more operations described herein in connection with FIG. 8. Additionally, or alternatively, the apparatus 1100 may be configured to perform one or more processes described herein, such as process 900 of FIG. 9, or a combination thereof. In some aspects, the apparatus 1100 and/or one or more components shown in FIG. 11 may include one or more components of the UE described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the UE described in connection with FIG. 2.

The transmission component 1104 may transmit communications, such as reference signals, control information, data communications, or a combination thereof, to the apparatus 1106. In some aspects, one or more other components of the apparatus 1100 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modem, a modulator, a transmit MIMO processor, a transmit processor, a controller/processor, a memory, or a combination thereof, of the UE described in connection with FIG. 2. In some aspects, the transmission component 1104 may be co-located with the reception component 1102 in a transceiver.

The reception component 1102 may receive information indicating a condition for a conditional handover, and an indication to communicate on a source cell after transmitting a message on a target cell, associated with the conditional handover, and before receiving an additional message on the target cell. The transmission component 1104 may transmit the message on the target cell responsive to the condition for the conditional handover being satisfied. The evaluation component 1108 may monitor whether the condition for conditional handover is satisfied and/or may determine that the condition for conditional handover is satisfied.

The reception component 1102 and/or the transmission component 1104 may communicate on the source cell, in accordance with the indication, after transmitting the message on the target cell and before receiving the additional message on the target cell.

The storage component 1110 may store at least one of first information relating to communicating on the source cell or second information relating to communicating on the target cell.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

FIG. 12 is a diagram of an example apparatus 1200 for wireless communication, in accordance with the present disclosure. The apparatus 1200 may be a network node, or a network node may include the apparatus 1200. In some aspects, the apparatus 1200 includes a reception component 1202 and a transmission component 1204, which may be in communication with one another (for example, via one or more buses and/or one or more other components). As shown, the apparatus 1200 may communicate with another apparatus 1206 (such as a UE, a base station, or another wireless communication device) using the reception component 1202 and the transmission component 1204. As further shown, the apparatus 1200 may include the communication manager 150. The communication manager 150 may include a generation component 1208, among other examples.

In some aspects, the apparatus 1200 may be configured to perform one or more operations described herein in connection with FIG. 8. Additionally, or alternatively, the apparatus 1200 may be configured to perform one or more processes described herein, such as process 1000 of FIG. 10, or a combination thereof. In some aspects, the apparatus 1200 and/or one or more components shown in FIG. 12 may include one or more components of the network node described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1206. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, a modem, a demodulator, a MIMO detector, a receive processor, a controller/processor, a memory, or a combination thereof, of the network node described in connection with FIG. 2.

The transmission component 1204 may transmit communications, such as reference signals, control information, data communications, or a combination thereof, to the apparatus 1206. In some aspects, one or more other components of the apparatus 1200 may generate communications and may provide the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, a modem, a modulator, a transmit MIMO processor, a transmit processor, a controller/processor, a memory, or a combination thereof, of the network node described in connection with FIG. 2. In some aspects, the transmission component 1204 may be co-located with the reception component 1202 in a transceiver.

The generation component 1208 may generate information indicating a condition for a conditional handover, and an indication that a UE is to communicate on a source cell after transmitting a message on a target cell, associated with the conditional handover, and before receiving an additional message on the target cell. The transmission component 1204 may transmit the information indicating the condition for the conditional handover, and the indication that the UE is to communicate on the source cell after transmitting the message on the target cell, associated with the conditional handover, and before receiving the additional message on the target cell.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The following provides an overview of some Aspects of the present disclosure:

Aspect 1: A method of wireless communication performed by an apparatus of a user equipment (UE), comprising: receiving information indicating a condition for a conditional handover, and an indication to communicate on a source cell after transmitting a message on a target cell, associated with the conditional handover, and before receiving an additional message on the target cell; and transmitting the message on the target cell responsive to the condition for the conditional handover being satisfied.

Aspect 2: The method of Aspect 1, further comprising: communicating on the source cell, in accordance with the indication, after transmitting the message on the target cell and before receiving the additional message on the target cell.

Aspect 3: The method of Aspect 2, wherein communicating on the source cell is during at least a portion of a round trip time, between the UE and a network node associated with the target cell, from the message on the target cell being transmitted.

Aspect 4: The method of any of Aspects 1-3, wherein the indication indicates an additional condition for communicating on the source cell.

Aspect 5: The method of Aspect 4, wherein the additional condition relates to one or more of: a round-trip time between the UE and a network node associated with the target cell, a type of a satellite used for communicating on the target cell, a configuration of the UE, a measurement performed by the UE, or the condition for the conditional handover.

Aspect 6: The method of any of Aspects 1-5, wherein the indication is based at least in part on one or more of: a type of a satellite used for communicating on the target cell, ephemeris information associated with the satellite, a reported location of the UE, or information relating to traffic and quality of service (QoS) requirements at the UE.

Aspect 7: The method of any of Aspects 1-6, wherein the indication is one of multiple indications, and wherein each of the multiple indications is associated with at least one of a respective candidate target cell or a respective conditional handover event.

Aspect 8: The method of any of Aspects 1-7, further comprising: storing at least one of first information relating to communicating on the source cell or second information relating to communicating on the target cell.

Aspect 9: The method of Aspect 8, wherein the first information is stored in association with first ephemeris information associated with the source cell, or the second information is stored in association with second ephemeris information associated with the target cell.

Aspect 10: The method of any of Aspects 1-9, wherein the message is a first message of a random access procedure, a third message of the random access procedure, or a radio resource control reconfiguration completion message, and wherein the additional message is a second message of the random access procedure, a fourth message of the random access procedure, or a downlink communication.

Aspect 11: The method of any of Aspects 1-10, further comprising: refraining from resetting a medium access control entity associated with the source cell or re-establishing a radio link control entity associated with the source cell.

Aspect 12: The method of any of Aspects 1-11, wherein the target cell is associated with a non-terrestrial network.

Aspect 13: A method of wireless communication performed by an apparatus of a network node, comprising: generating information indicating a condition for a conditional handover, and an indication that a user equipment (UE) is to communicate on a source cell after transmitting a message on a target cell, associated with the conditional handover, and before receiving an additional message on the target cell; and transmitting the information indicating the condition for the conditional handover, and the indication that the UE is to communicate on the source cell after transmitting the message on the target cell, associated with the conditional handover, and before receiving the additional message on the target cell.

Aspect 14: The method of Aspect 13, wherein the indication indicates an additional condition for communicating on the source cell.

Aspect 15: The method of Aspect 14, wherein the additional condition relates to one or more of: a round-trip time between the UE and a network node associated with the target cell, a type of a satellite used for communicating on the target cell, a configuration of the UE, a measurement performed by the UE, or the condition for the conditional handover.

Aspect 16: The method of any of Aspects 13-15, wherein the indication is based at least in part on one or more of: a type of a satellite used for communicating on the target cell, ephemeris information associated with the satellite, a reported location of the UE, or information relating to traffic and quality of service (QoS) requirements at the UE.

Aspect 17: The method of any of Aspects 13-16, wherein the indication is one of multiple indications, and wherein each of the multiple indications is associated with at least one of a respective candidate target cell or a respective conditional handover event.

Aspect 18: The method of any of Aspects 13-17, wherein the message is a first message of a random access procedure, a third message of the random access procedure, or a radio resource control reconfiguration completion message, and wherein the additional message is a second message of the random access procedure, a fourth message of the random access procedure, or a downlink communication.

Aspect 19: The method of any of Aspects 13-18, wherein the target cell is associated with a non-terrestrial network.

Aspect 20: An apparatus for wireless communication at a device, comprising a processor; memory coupled with the processor; and instructions stored in the memory and executable by the processor to cause the apparatus to perform the method of one or more of Aspects 1-12.

Aspect 21: A device for wireless communication, comprising a memory and one or more processors coupled to the memory, the one or more processors configured to perform the method of one or more of Aspects 1-12.

Aspect 22: An apparatus for wireless communication, comprising at least one means for performing the method of one or more of Aspects 1-12.

Aspect 23: A non-transitory computer-readable medium storing code for wireless communication, the code comprising instructions executable by a processor to perform the method of one or more of Aspects 1-12.

Aspect 24: A non-transitory computer-readable medium storing a set of instructions for wireless communication, the set of instructions comprising one or more instructions that, when executed by one or more processors of a device, cause the device to perform the method of one or more of Aspects 1-12.

Aspect 25: An apparatus for wireless communication at a device, comprising a processor; memory coupled with the processor; and instructions stored in the memory and executable by the processor to cause the apparatus to perform the method of one or more of Aspects 13-19.

Aspect 26: A device for wireless communication, comprising a memory and one or more processors coupled to the memory, the one or more processors configured to perform the method of one or more of Aspects 13-19.

Aspect 27: An apparatus for wireless communication, comprising at least one means for performing the method of one or more of Aspects 13-19.

Aspect 28: A non-transitory computer-readable medium storing code for wireless communication, the code comprising instructions executable by a processor to perform the method of one or more of Aspects 13-19.

Aspect 29: A non-transitory computer-readable medium storing a set of instructions for wireless communication, the set of instructions comprising one or more instructions that, when executed by one or more processors of a device, cause the device to perform the method of one or more of Aspects 13-19.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a user equipment (UE), comprising:
a memory; and
one or more processors, coupled to the memory, configured to:
receive information indicating a condition for a conditional handover, and an indication to communicate on a source cell after transmitting a message on a target cell, associated with the conditional handover, and before receiving an additional message on the target cell; and
transmit the message on the target cell responsive to the condition for the conditional handover being satisfied.

2. The apparatus of claim 1, wherein the one or more processors are further configured to:
communicate on the source cell, in accordance with the indication, after transmitting the message on the target cell and before receiving the additional message on the target cell.

3. The apparatus of claim 2, wherein the one or more processors, to communicate on the source cell, are configured to:
communicate on the source cell during at least a portion of a round trip time, between the UE and a network node associated with the target cell, from the message on the target cell being transmitted.

4. The apparatus of claim 1, wherein the indication indicates an additional condition for communicating on the source cell.

5. The apparatus of claim 4, wherein the additional condition relates to one or more of:
a round-trip time between the UE and a network node associated with the target cell,
a type of a satellite used for communicating on the target cell,
a configuration of the UE,
a measurement performed by the UE, or
the condition for the conditional handover.

6. The apparatus of claim 1, wherein the indication is based at least in part on one or more of:
a type of a satellite used for communicating on the target cell,
ephemeris information associated with the satellite,
a reported location of the UE, or
information relating to traffic and quality of service (QoS) requirements at the UE.

7. The apparatus of claim 1, wherein the indication is one of multiple indications, and
wherein each of the multiple indications is associated with at least one of a respective candidate target cell or a respective conditional handover event.

8. The apparatus of claim 1, wherein the one or more processors are further configured to:
store at least one of first information relating to communicating on the source cell or second information relating to communicating on the target cell.

9. The apparatus of claim 8, wherein the first information is to be stored in association with first ephemeris information associated with the source cell, or the second information is to be stored in association with second ephemeris information associated with the target cell.

10. The apparatus of claim 1, wherein the message is a first message of a random access procedure, a third message of the random access procedure, or a radio resource control reconfiguration completion message, and
wherein the additional message is a second message of the random access procedure, a fourth message of the random access procedure, or a downlink communication.

11. The apparatus of claim 1, wherein the one or more processors are further configured to:
refrain from resetting a medium access control entity associated with the source cell or re-establishing a radio link control entity associated with the source cell.

12. The apparatus of claim 1, wherein the target cell is associated with a non-terrestrial network.

13. An apparatus for wireless communication at a network node, comprising:
a memory; and
one or more processors, coupled to the memory, configured to:
generate information indicating a condition for a conditional handover, and an indication that a user equipment (UE) is to communicate on a source cell after transmitting a message on a target cell, associated with the conditional handover, and before receiving an additional message on the target cell; and
transmit the information indicating the condition for the conditional handover, and the indication that the UE is to communicate on the source cell after transmitting the message on the target cell, associated with the conditional handover, and before receiving the additional message on the target cell.

14. The apparatus of claim 13, wherein the indication indicates an additional condition for communicating on the source cell.

15. The apparatus of claim 14, wherein the additional condition relates to one or more of:
a round-trip time between the UE and a network node associated with the target cell,
a type of a satellite used for communicating on the target cell,
a configuration of the UE,
a measurement performed by the UE, or
the condition for the conditional handover.

16. The apparatus of claim 13, wherein the indication is based at least in part on one or more of:
a type of a satellite used for communicating on the target cell,
ephemeris information associated with the satellite,
a reported location of the UE, or
information relating to traffic and quality of service (QoS) requirements at the UE.

17. The apparatus of claim 13, wherein the indication is one of multiple indications, and
wherein each of the multiple indications is associated with at least one of a respective candidate target cell or a respective conditional handover event.

18. The apparatus of claim 13, wherein the message is a first message of a random access procedure, a third message of the random access procedure, or a radio resource control reconfiguration completion message, and
wherein the additional message is a second message of the random access procedure, a fourth message of the random access procedure, or a downlink communication.

19. The apparatus of claim 13, wherein the target cell is associated with a non-terrestrial network.

20. A method of wireless communication performed by an apparatus of a user equipment (UE), comprising:
receiving information indicating a condition for a conditional handover, and an indication to communicate on a source cell after transmitting a message on a target cell, associated with the conditional handover, and before receiving an additional message on the target cell; and
transmitting the message on the target cell responsive to the condition for the conditional handover being satisfied.

21. The method of claim 20, further comprising:
communicating on the source cell, in accordance with the indication, after transmitting the message on the target cell and before receiving the additional message on the target cell.

22. The method of claim 21, wherein communicating on the source cell is during at least a portion of a round trip time, between the UE and a network node associated with the target cell, from the message on the target cell being transmitted.

23. The method of claim 20, wherein the indication indicates an additional condition for communicating on the source cell.

24. The method of claim 20, wherein the indication is based at least in part on one or more of:
a type of a satellite used for communicating on the target cell,
ephemeris information associated with the satellite,
a reported location of the UE, or
information relating to traffic and quality of service (QoS) requirements at the UE.

25. The method of claim 20, wherein the indication is one of multiple indications, and
wherein each of the multiple indications is associated with at least one of a respective candidate target cell or a respective conditional handover event.

26. The method of claim 20, further comprising:
storing at least one of first information relating to communicating on the source cell or second information relating to communicating on the target cell.

27. The method of claim 20, wherein the message is a first message of a random access procedure, a third message of the random access procedure, or a radio resource control reconfiguration completion message, and
wherein the additional message is a second message of the random access procedure, a fourth message of the random access procedure, or a downlink communication.

28. A method of wireless communication performed by an apparatus of a network node, comprising:
generating information indicating a condition for a conditional handover, and an indication that a user equipment (UE) is to communicate on a source cell after transmitting a message on a target cell, associated with the conditional handover, and before receiving an additional message on the target cell; and
transmitting the information indicating the condition for the conditional handover, and the indication that the UE is to communicate on the source cell after transmitting the message on the target cell, associated with the conditional handover, and before receiving the additional message on the target cell.

29. The method of claim 28, wherein the indication indicates an additional condition for communicating on the source cell.

30. The method of claim 28, wherein the message is a first message of a random access procedure, a third message of the random access procedure, or a radio resource control reconfiguration completion message, and
wherein the additional message is a second message of the random access procedure, a fourth message of the random access procedure, or a downlink communication.
